(19) United States
(12) Patent Application Publication
(10) Pub. No.: US 2020/0079896 A1
(43) Pub. Date: Mar. 12, 2020

(54) CURABLE RESIN COMPOSITION FOR THREE-DIMENSIONAL MOLDING

(71) Applicant: CANON KABUSHIKI KAISHA, Tokyo (JP)

(72) Inventor: Chiaki Nishiura, Tokyo (JP)

(21) Appl. No.: 16/564,754

(22) Filed: Sep. 9, 2019

(30) Foreign Application Priority Data
Sep. 12, 2018 (JP) 2018-170181
Aug. 7, 2019 (JP) 2019-145162

(51) Int. Cl. C08G 59/24; C08K 3/28; C08K 3/16; C08K 3/38; C08K 3/011

(52) U.S. Cl. CPC C08G 59/24; C08K 3/28; C08K 3/16; B33Y 70/00; C08K 3/011; C08K 2003/385; C08K 3/38

(57) ABSTRACT

A curable resin composition for three-dimensional molding including a cationic polymerizable compound (A); an inorganic particle (B); and a curing agent (C), in which a flexural modulus of a cured product obtained by polymerizing a composition consisting of the cationic polymerizable compound (A) and the curing agent (C) is 2.0 GPa or more, the inorganic particle (B) has a layered crystal structure, a content of the inorganic particle (B) is 10 parts by mass or more and 30 parts by mass or less, relative to total 100 parts by mass of the cationic polymerizable compound (A) and the inorganic particle (B), and the curable resin composition having a thickness of 200 μm has a light transmittance including forward scattering of 0.1% or more at a wavelength of 365 nm or 405 nm.

### BACKGROUND OF THE INVENTION

### Field of the Invention

The present disclosure relates to a curable resin composition and a method of producing a three-dimensional molded product using the same.

### Description of the Related Art

As an example of applications of a liquid curable resin composition, an optical three-dimensional molding method (optical molding method) of producing a desired three-dimensional product by curing each layer of the curable resin composition with light such as ultraviolet light and sequentially laminating the layers has been intensively studied. The application of the optical molding method is not limited to the molding of prototypes (rapid prototyping) for shape confirmation, but has been spreading to the molding of working models, the molding of molds (rapid tooling), and the like for functional verification. In addition, the application of the optical molding method has been spreading to the molding of real products (rapid manufacturing).

From such a background, the demand for a curable resin composition has been increased. Recently, a curable resin composition capable of molding a three-dimensional molded product having high abrasion resistance of a cured product, which is comparable to general-purpose engineering plastics, has been required. In order to enhance the abrasion resistance of the cured product, it is generally well known to lower surface free energy of a curable resin composition, add a solid lubricant to the curable resin composition, and contain a liquid lubricant such as oil, as a method of lowering the coefficient of friction and improving the releasing properties and sliding properties. In addition, in order to improve molding accuracy, it is generally well known to add glass beads and inorganic compounds to the curable resin composition, and many studies have been conducted so far.

Japanese Patent Application Laid-Open No. H09-268205 proposes a resin composition for optical three-dimensional molding excellent in molding accuracy, which is obtained by adding an inorganic filler such as glass powder or alumina powder to alicyclic epoxy. In addition, Japanese Patent Application Laid-Open No. H07-026060 proposes a resin composition for optical three-dimensional molding having a small volume shrinkage ratio, in which an inorganic filler such as glass beads, and a polymer filler such as polystyrene beads or polyethylene beads are added to urethane acrylate.

It is desirable that a curable resin composition for three-dimensional molding not only has high accuracy in molding a cured product, but also has a low coefficient of friction of the cured product and high abrasion resistance. However, it is difficult to satisfy all these physical properties at once, and there is no example in which a component for improving the sliding properties is blended in the resin compositions disclosed in Japanese Patent Application Laid-Open No. H09-268205 and Japanese Patent Application Laid-Open No. H07-026060, and thus the sliding properties of the cured product were not good enough.

### SUMMARY OF THE INVENTION

A curable resin composition for three-dimensional molding includes (A) a cationic polymerizable compound; (B) an inorganic particle; and (C) a curing agent, in which a flexural modulus of a cured product obtained by polymerizing a composition consisting of the cationic polymerizable compound (A) and the curing agent (C) is 2.0 GPa or more, the inorganic particle (B) has a layered crystal structure, a content of the inorganic particle (B) is 10 parts by mass or more and 30 parts by mass or less, relative to 100 parts by mass of the cationic polymerizable compound (A) and the inorganic particle (B) in total, and the curable resin composition having a thickness of 200 μm has a light transmittance including forward scattering of 0.1% or more at a wavelength of 365 nm or 405 nm.

Further features of the present disclosure will become apparent from the following description of exemplary embodiments.

### DESCRIPTION OF THE EMBODIMENTS

In the present disclosure, in order to solve the above-described disadvantage, an aspect of the present disclosure is to provide a curable resin composition for three-dimensional molding which can obtain a cured product having high molding accuracy, high abrasion resistance, and high sliding properties.

Hereinafter, embodiments of the present disclosure are described. The embodiment described below is merely an embodiment of the present disclosure, and the present invention is not limited to these embodiments.

<Cationic Polymerizable Compound (A)>

As a cationic polymerizable compound (A), a cationic polymerizable compound in which a flexural modulus of a cured product obtained by polymerizing a composition consisting of the cationic polymerizable compound (A) and a curing agent (C) is 2.0 GPa or more, and is preferably 3.0 GPa or more is used. Here, the composition consisting of the cationic polymerizable compound (A) and the curing agent (C) means a composition obtained by removing components other than the cationic polymerizable compound (A) and the curing agent (C) from the curable resin composition.

The cationic polymerizable compound is a generic term for compounds that undergo a polymerization reaction in the presence of a cation. Examples of a cationic polymerizable compound include an epoxy compound, an oxetane compound, and a vinyl ether compound. Among them, an epoxy compound is preferable.

The cationic polymerizable compound (A) may be configured of a single of cationic polymerizable compound or a mixture of two or more kinds of cationic polymerizable compounds. In a case where two or more kinds of the cationic polymerizable compounds are used as the cationic polymerizable compound (A), a flexural modulus of the cured product obtained by polymerizing a composition consisting of the cationic polymerizable compound (A) consisting of two or more kinds of the cationic polymerizable compound and the curing agent (C) may be 2.0 GPa or more.

[Epoxy Compound]

The epoxy compound used in the present disclosure is not particularly limited as long as it is a compound having an epoxy group, and may be composed of only one kind of epoxy compound, or may be composed of a plurality of epoxy compounds.

Examples of the epoxy compound include a resin containing an epoxy group (prepolymer) and an alicyclic epoxy compound.

Examples of the resin containing an epoxy group (prepolymer) include a bisphenol A type epoxy resin, a bisphenol F type epoxy resin, a biphenyl type epoxy resin, a tetramethylbiphenyl type epoxy resin, a naphthalene type epoxy resin, a phenolic type novolac epoxy resin, a cresol novolac type epoxy resin, a triphenylmethane type epoxy resin, a tetraphenylethane type epoxy resin, a dicyclopentadiene-phenol addition reaction type epoxy resin, a phenol aralkyl type epoxy resin, a naphthol novolac type epoxy resin, a naphthol aralkyl type epoxy resin, a naphthol-phenol co-convoluted novolac type epoxy resin, a naphthol-cresol co-contracted novolak type epoxy resin, an aromatic hydrocarbon formaldehyde resin modified phenolic resin type epoxy resin, a biphenyl modified novolac type epoxy resin, and a naphthalene ether type epoxy resin.

From the viewpoint of the elastic modulus of the cured product and the reaction rate, an alicyclic epoxy compound is preferable. Examples of the alicyclic epoxy compound include a compound having an epoxy group on a ring of alicyclic alkyl group, such as compounds having an epoxy cyclobutyl group, an epoxy cyclopentyl group, an epoxy cyclohexyl group, an epoxy cycloheptyl group, and an epoxy cyclooctyl group. From the viewpoint of availability of materials and reactivity, compounds having an epoxycyclohexyl group are preferable.

Specific examples include a monofunctional alicyclic epoxy compound such as 1,2-epoxycyclopentane, 1,2-epoxycyclohexane, 1,2-epoxycycloheptane, 1,2-epoxycyclooctane, 1-methyl-1,2-epoxycyclohexane, 2,3-epoxy norbornene, isophorone oxide, and vinylcyclohexene monoepoxide; and a bifunctional alicyclic epoxy compound such as 3,4-epoxycyclohexylmethyl-3′,4′-epoxycyclohexanecarboxylate, bis(3,4-epoxycyclohexylmethyl) adipate, ε-caprolactone modified 3,4-epoxycyclohexylmethyl 3′,4′-epoxycyclohexane carboxylate, and 1-methyl-4-(2-methyloxiranyl)-7-oxabicyclo [4,1,0] heptane.

Commercial products can be used as an alicyclic epoxy compound, and examples thereof include UVR 6105, UVR 6110, and UVR 6128 (which are manufactured by Union Carbide Corporation), CELOXIDE 2021P, CELOXIDE 2081, and CELOXIDE 3000 (which are manufactured by Daicel Corporation).

Since the elastic modulus of the cured product can be increased by a crosslinked structure, an alicyclic epoxy compound is preferably a bifunctional alicyclic epoxy compound, and a structure is more preferably a bifunctional alicyclic epoxy compound represented by the following Formulae (1) to (3).

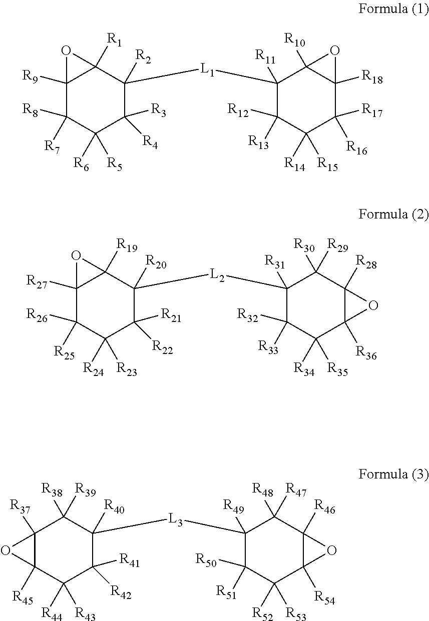

R₁ to R₅₄ each represent a hydrogen atom, a hydroxyl group, or an alkyl group having 1 to 6 carbon atoms. Examples of the alkyl group include a linear or branched alkyl group such as a methyl group, an ethyl group, a propyl group, a t-butyl group, a pentyl group, and a hexyl group; and a cyclic alkyl group such as a cyclopropyl group, a cyclobutyl group, a cyclopentyl group, and a cyclohexyl group. R₁, R₉, R₁₀, R₁₈, R₁₉, R₂₇, R₂₈, R₃₆, R₃₇, R₄₅, R₄₆, and R₅₄ are preferably hydrogen atoms from the viewpoint of reactivity. Further, R₁ to R₅₄ are preferably hydrogen atoms from the viewpoint of availability.

L₁ to L₃ each represent a divalent linking group having an ether structure, an ester structure, or a carbonate structure. From the viewpoint of the availability of commercial products, L₁ to L₃ preferably have an ester structure.

Furthermore, from the viewpoint of availability, alicyclic epoxy is a bifunctional alicyclic epoxy compound represented by Formula (3), and R₃₇ to R₅₄ are preferably hydrogen atoms, and more preferably one having an ester structure in L₃ which is a divalent linking group.

[Oxetane Compound]

The oxetane compound is not particularly limited as long as it is a compound having an oxetanyl group, and may be composed of only one kind of oxetane compound or may be composed of a plurality of oxetane compounds.

The number of oxetanyl groups in the oxetane compound is not particularly limited. Examples of the oxetane compound include a monofunctional oxetane compound having one oxetanyl group in the molecule, a bifunctional oxetane compound having two oxetanyl groups in the molecule, a trifunctional oxetane compound having three oxetanyl groups in the molecule, and a tetrafunctional or higher oxetane compound having four or more oxetanyl groups in the molecule; however, the examples thereof are not limited thereto.

In addition, as the oxetane compound, an oxetane compound having an aromatic ring or an ether bond in the molecule may be used.

Specific examples of the oxetane compound include a mono-oxetane compound such as 3-ethyl-3-[(2-ethylhexyloxy) methyl] oxetane, 3-ethyl-3-hydroxymethyl oxetane, 3-ethyl-3-(4-hydroxybutyl) oxymethyl oxetane, 3-ethyl-3-hexyloxymethyl oxetane, 3-ethyl-3-allyloxymethyl oxetane, 3-ethyl-3-benzyloxymethyl oxetane, 3-ethyl-3-methacryloxymethyl oxetane, 3-ethyl-3-carboxy oxetane, and 3-ethyl-3-phenoxymethyl oxetane; a dioxetane compound such as bis[1-ethyl(3-oxetanyl)] methyl ether, 4,4′-bis[3-ethyl-(3-oxetanyl) methoxymethyl] biphenyl, 1,4-bis(3-ethyl-3-oxetanyl methoxy) methyl benzene, xylylene bisoxetane, bis[(ethyl(3-oxetanyl)] methyl carbonate, bis[ethyl (3-oxetanyl)] ethyl adipate, bis[ethyl (3-oxetanyl)] methyl terephthalate, bis[ethyl(3-oxetanyl)] methyl 1,4-cyclohexanecarboxylate, bis{4-[ethyl(3-oxetanyl) methoxycarbonylamino] phenyl} methane, and α,ω-bis-{3-[1-ethyl(3-oxetanyl) methoxy] propyl} (polydimethylsiloxane); and a polyoxetane compound such as oligo (glycidyl oxetane-co-phenyl glycidyl ether); however, the examples thereof are not limited thereto.

Among the oxetane compounds, from the viewpoint of low viscosity, easy to handle, and high reactivity, bis[1-ethyl (3-oxetanyl)] methyl ether,4,4′-bis[3-ethyl-(3-oxetanyl) methoxymethyl] biphenyl, 3-ethyl-3-[(2-ethylhexyloxy) methyl] oxetane, 3-ethyl-3-hydroxymethyl oxetane, 3-ethyl-3-(4-hydroxybutyl) oxymethyl oxetane, 1,4-bis(3-ethyl-3-oxetanyl methoxy) methyl benzene, and xylylene bisoxetane are preferable, and bis[1-ethyl (3-oxetanyl)] methyl ether,4,4′-bis[3-ethyl-(3-oxetanyl) methoxymethyl] biphenyl, 3-ethyl-3-[(2-ethylhexyloxy) methyl] oxetane, 3-ethyl-3-hydroxymethyl oxetane, and 3-ethyl-3-(4-hydroxybutyl) oxymethyl oxetane are more preferable.

As the oxetane compound, commercially available products having a cationic polymerizable monomer as a main component can be used, and examples thereof include Aron oxetane (trademark) OXT-121, OXT-221, EXOH, PDX, OXA, OXT-101, OXT-211, and OXT-212 (manufactured by Toagosei Co., Ltd.), ETERNACOLL (trademark) OXBP and OXTP (manufactured by Ube Industries, Ltd.).

<Inorganic Particle (B)>

An inorganic particle (B) has a layered crystal structure. The inorganic particle (B) having a layered crystal structure refers to, for example, an inorganic particle which has a hexagonal crystal structure such as graphite, and in which layers in flush with each other are strongly connected by covalent bonds, but the layers are bonded by weak van der Waals force. Examples of the inorganic particle having such a structure include graphite, molybdenum disulfide, tungsten disulfide, boron nitride, graphite fluoride, silicon nitride, molybdenum selenide, molybdenum diselenide, tantalum diselenide, titanium ditelluride, gallium sulfide, gallium selenide, tin selenide, cadmium chloride, cobalt chloride, lead chloride, cerium trifluoride, lead iodide, talc, and mica. Among them, when using the inorganic particle that absorbs less light, such as boron nitride, graphite fluoride, silicon nitride, and talc, the light transmittance of the resin composition can be kept high. Accordingly, from the viewpoint of curability, any of graphite fluoride, boron nitride, and silicon nitride is particularly preferable as the inorganic particle (B).

If the particle diameter of the inorganic particle (B) is excessively small, the viscosity of the resin composition is significantly increased, and thus it is preferably 0.1 μm or more, and more preferably 1 μm or more. On the other hand, if the particle diameter is excessively large, sedimentation tends to occur in the resin composition, and the light transmittance to be described later also deteriorates, and thus it is preferably 100 μm or less, and more preferably 50 μm or less. In addition, the particle diameter here refers to an average particle diameter calculated by a laser diffraction method.

The additional amount of the inorganic particles (B) is 10 parts by mass or more and 30 parts by mass or less, and is preferably 20 parts by mass or more and 30 parts by mass or less, relative to total 100 parts by mass of the cationic polymerizable compound (A) and the inorganic particle (B). If the additional amount of the inorganic particles (B) is excessively small, the effects of improving the molding accuracy, reducing the coefficient of friction (improving slidability), and improving the abrasion resistance become small, and thus it is preferably 10 parts by mass or more, relative to total 100 parts by mass of the cationic polymerizable compound (A) and the inorganic particle (B). On the other hand, if the additional amount of the inorganic particles (B) is excessively large, the effect of improving the abrasion resistance become small, the viscosity of the resin composition is increased, and the transmittance of the light described below is reduced, and thus it is preferable 30 parts by mass or less, relative to total 100 parts by mass of the cationic polymerizable compound (A) and the inorganic particle (B).

<Curing Agent (C)>

As the curing agent (C), it is preferable to use a photopolymerization initiator, and it is more preferable to use a photocationic polymerization initiator. These may be used alone or in combination as long as the effects of the present disclosure are not impaired. In addition to the photocationic polymerization initiator, other curing agents such as a thermal cationic polymerization initiator, a radical polymerization initiator, an anionic polymerization initiator, and a thermal latent curing agent may be contained.

[Photocationic Polymerization Initiator]

The photocationic polymerization initiator is also called a photoacid generator. The irradiation of energy rays such as ultraviolet light generates an acid capable of initiating cationic polymerization.

As the photocationic polymerization initiator, onium salts in which a cation moiety is aromatic sulfonium, aromatic iodonium, aromatic diazonium, aromatic ammonium, thianthrenium, thioxanthonium, (2,4-cyclopentadien-1-yl) [(1-methylethylbenzene)]-Fe cation and, an anion moiety is BF4⁻, PF₆⁻, SbF₆⁻, and [BX₄]⁻ (here, X is a phenyl group substituted with at least two or more fluorine or trifluoromethyl groups) can be used alone or in combination of two or more.

Examples of the aromatic sulfonium salt include bis[4-(diphenylsulfonio) phenyl] sulfide bishexafluorophosphate, bis[4-(diphenylsulfonio) phenyl] sulfide bishexafluoroantimonate, bis[4-(diphenylsulfonio) phenyl] sulfide bis tetrafluoroborate, bis[4-(diphenylsulfonio) phenyl] sulfide tetrakis (pentafluorophenyl) borate, diphenyl-4-(phenylthio) phenylsulfonium hexafluorophosphate, diphenyl-4-(phenylthio) phenylsulfonium hexafluoroantimonate, diphenyl-4-(phenylthio) phenylsulfonium tetrafluoroborate, diphenyl-4-(phenylthio) phenylsulfonium tetrakis (pentafluorophenyl) borate, triphenylsulfonium hexafluorophosphate, triphenylsulfonium hexafluoroantimonate, triphenylsulfonium tetrafluoroborate, triphenylsulfonium tetrakis (pentafluorophenyl) borate, bis[4-(di(4-(2-hydroxyethoxy)) phenyl sulfonio) phenyl] sulfide bishexafluorophosphate, bis[4-(di(4-(2-hydroxyethoxy)) phenyl sulfonio) phenyl] sulfide bishexafluoroantimonate, bis[4-(di(4-(2-hydroxyethoxy)) phenyl sulfonio) phenyl] sulfide bis tetrafluoroborate, and bis[4-(di(4-(2-hydroxyethoxy)) phenyl sulfonio) phenyl] sulfide tetrakis (pentafluorophenyl) borate.

In addition, examples of the aromatic iodonium salt include diphenyliodonium hexafluorophosphate, diphenyliodonium hexafluoroantimonate, diphenyliodonium tetrafluoroborate, diphenyliodonium tetrakis (pentafluorophenyl) borate, bis(dodecylphenyl) iodonium hexafluorophosphate, bis(dodecylphenyl) iodonium hexafluoroantimonate, bis(dodecylphenyl) iodonium tetrafluoroborate, bis(dodecylphenyl) iodonium tetrakis (pentafluorophenyl) borate, 4-methylphenyl-4-(1-methylethyl) phenyliodonium hexafluorophosphate, 4-methylphenyl-4-(1-methylethyl) phenyliodonium hexafluoroantimonate, 4-methylphenyl-4-(1-methylethyl) phenyliodonium tetrafluoroborate, and 4-methylphenyl-4-(1-methylethyl) phenyliodonium tetrakis (pentafluorophenyl) borate.

In addition, examples of the aromatic diazonium salt include phenyl diazonium hexafluorophosphate, phenyl diazonium hexafluoroantimonate, phenyl diazonium tetrafluoroborate, and phenyl diazonium tetrakis (pentafluorophenyl) borate.

In addition, examples of the aromatic ammonium salt include 1-benzyl-2-cyanopyridinium hexafluorophosphate, 1-benzyl-2-cyanopyridinium hexafluoroantimonate, 1-benzyl-2-cyanopyridinium tetrafluoroborate, 1-benzyl-2-cyanopyridinium tetrakis (pentafluorophenyl) borate, 1-(naphthylmethyl)-2-cyanopyridinium hexafluorophosphate, 1-(naphthylmethyl)-2-cyanopyridinium hexafluoroantimonate, 1-(naphthylmethyl)-2-cyanopyridinium tetrafluoroborate, and 1-(naphthylmethyl)-2-cyanopyridinium tetrakis (pentafluorophenyl) borate.

In addition, examples of the thianthreniumsalt include 5-methylthianthrenium hexafluorophosphate, 5-methyl-10-oxothianthrenium tetrafluoroborate, and 5-methyl-10,10-dioxothianthrenium hexafluorophosphate.

In addition, examples of the thioxanthonium salt include S-biphenyl 2-isopropylthioxanthonium hexafluorophosphate.

Also, as (2,4-cyclopentadien-1-yl) [(1-methylethyl) benzene]-Fe salt, (2,4-cyclopentadien-1-yl) [(1-methylethylbenzene)]-Fe (II) hexafluorophosphate, (2,4-cyclopentadien-1-yl) [(1-methylethylbenzene)]-Fe (II) hexafluoroantimonate, (2,4-cyclopentadien-1-yl) [(1-methylethylbenzene)]-Fe (II) tetrafluoroborate, and (2,4-cyclopentadien-1-yl) [(1-methylethylbenzene)]-Fe (II) tetrakis (pentafluorophenyl) borate.

Examples of commercially available photocationic polymerization initiators include CPI(trademark)-100P, CPI(trademark)-110P, CPI(trademark)-101A, CPI(trademark)-200K, CPI(trademark)-210S (which are manufactured by San-Apro Ltd.), CYRACURE (trademark) photocuring initiator UVI-6990, CYRACURE (trademark) photocuring initiator UVI-6992, and CYRACURE (trademark) photocuring initiator UVI-6976 (which are manufactured by Dow Chemical Japan Limited), ADEKA OPTOMER SP-150, ADEKA OPTOMER SP-152, ADEKA OPTOMER SP-170, ADEKA OPTOMER SP-172, and ADEKA OPTOMER SP-300 (which are manufactured by ADEKA), CI-5102 and CI-2855 (which are manufactured by Nippon Soda Co., Ltd.), SAN-AID (trademark) SI-60L, SAN-AID (trademark) SI-80L, SAN-AID (trademark) SI-100L, SAN-AID (trademark) SI-110L, SAN-AID (trademark) SI-180L, SAN-AID (trademark) SI-110, and SAN-AID (trademark) SI-180 (which are manufactured by Sanshin Chemical Industry Co., Ltd.), ESACURE (trademark) 1064 and ESACURE (trademark) 1187 (which are manufactured by LAMBERTI), OMNICAT 550 (manufactured by IGM Resins), IRGACURE (trademark) 250 (manufactured by BASF), and RHODORSIL PHOTOINITIATOR 2074 (manufactured by Solvay Japan, Ltd.).

In the present disclosure, two or more types of the photocationic polymerization initiator may be used in combination. In addition, the photocationic polymerization initiator may be used alone. Moreover, in order to advance a polymerization reaction by a heat treatment after molding, other curing agents such as a thermal cationic polymerization initiator may be simultaneously contained.

The additional amount of the photocationic polymerization initiator is preferably 0.1 parts by mass or more and 15 parts by mass or less, and is more preferably 0.1 parts by mass or more and 10 parts by mass or less, relative to 100 parts by mass of cationic polymerizable compound (A). If the amount of photocationic polymerization initiator is small, polymerization tends to be insufficient. If the amount of the photocationic polymerization initiator is large, the light transmittance may be reduced, and the polymerization may be nonuniform.

[Thermal Cationic Polymerization Initiator]

The thermal cationic polymerization initiator is also called a thermal acid generator. A compound containing a cationic species is excited by heating, and a thermal decomposition reaction occurs to exhibit a substantial function as a curing agent for promoting thermal curing. The thermal cationic polymerization initiator is different from acid anhydrides, amines, a phenol resin, and the like generally used as a curing agent, and even in a case of being contained in the resin composition, it does not cause a time-dependent increase in viscosity or gelation of the resin composition at room temperature. Therefore, it is possible to provide a one-component resin composition excellent in handling properties.

Examples of the thermal cationic polymerization initiator include diphenyliodonium hexafluoroarsenate, diphenyliodonium hexafluorophosphate, diphenyliodonium trifluoromethanesulfonate, triphenylsulfonium tetrafluoroborate, tri-p-tolylsulfonium hexafluorophosphate, tri-p-tolylsulfonium trifluoromethanesulfonate, bis(cyclohexylsulfonyl) diazomethane, bis(tert-butylsulfonyl) diazomethane, bis(p-toluenesulfonyl) diazomethane, triphenylsulfonium trifluoromethanesulfonate, diphenyl-4-methylphenylsulfonium trifluoromethanesulfonate, diphenyl-2,4,6-trimethylphenylsulfonium-p-toluenesulfonate, and diphenyl-p-phenylthiophenyl sulfonium hexafluorophosphate.

In the present disclosure, as the thermal cationic polymerization initiator, for example, commercial products such as AMERICURE series (manufactured by American scan), ULTRASET series (manufactured by ADEKA), and WPAG series (manufactured by Wako Pure Chemical Industries, Ltd.) which are diazonium salt compounds, UVE series (manufactured by General Electric Company), FC series (manufactured by 3M), UV9310C (manufactured by GE Toshiba Silicones), and WPI series (manufactured by Wako Pure Chemical Industries, Ltd.) which are iodonium salt compounds, and CYRACURE series (manufactured by Union Carbide Corporation), UVI series (manufactured by General Electric Company), FC series (manufactured by 3M), CD series (manufactured by Sartomer Company, Inc.), OPTOMER SP series, OPTOMER CP series (manufactured by ADEKA), SAN-AID SI series (manufactured by sanshin Chemical Industry Co., Ltd.), CI series (manufactured by Nippon Soda Co., Ltd.), WPAG series (manufactured by Wako Pure Chemical Industries, Ltd.), and CPI series (manufactured by San-Apro Ltd.) which are sulfonium salt compounds.

In the present disclosure, two or more types of the thermal cationic polymerization initiator may be used in combination. In addition, the thermal cationic polymerization initiator may be used alone. Moreover, in order to advance a polymerization reaction by heat treatment after molding, the thermal cationic polymerization initiator which decomposes at high temperature may be used.

The additional amount of the thermal cationic polymerization initiator is preferably 0.1 parts by mass or more and 15 parts by mass or less, and is more preferably 0.1 parts by mass or more and 10 parts by mass or less, relative to 100 parts by mass of cationic polymerizable compound (A). If the amount of thermal cationic polymerization initiator is small, polymerization tends to be insufficient.

[Radical Polymerization Initiator]

In a case where as a reactive diluent (D) to be described later, the radical polymerizable compound is added to the curable resin composition of the present disclosure, a radical polymerization initiator can be used. The radical polymerization initiator is classified into a photoradical polymerization initiator and a thermal radical polymerization initiator.

(Photoradical Polymerization Initiator)

A photoradical polymerization initiator is mainly classified into an intramolecular cleavage type and a hydrogen abstraction type. In the intramolecular cleavage type, by absorbing light of a specific wavelength, the bond at a specific site is cleaved, and radical is generated at the cleaved site, which becomes a polymerization initiator, and polymerization of the reactive diluent (D) having radical polymerization property is started. In the hydrogen abstraction type, light of having a specific wavelength is absorbed to be in an excited state, the excited species cause a hydrogen abstraction reaction from the surrounding hydrogen donor to generate radical, and the radical becomes a polymerization initiator so that the polymerization of the reactive diluent (D) having radical polymerization property is started.

Examples of the intramolecular cleavage type photoradical polymerization initiator include an alkylphenone photoradical polymerization initiator, an acyl phosphine oxide photoradical polymerization initiator, and an oxime ester photoradical polymerization initiator. These are of the type in which the bond adjacent to the carbonyl group is alpha-cleaved to form a radical species. Examples of the alkylphenone photoradical polymerization initiator include a benzyl methyl ketal photoradical polymerization initiator, an α-hydroxyalkylphenone photoradical polymerization initiator, and an aminoalkylphenone photoradical polymerization initiator. As a specific compound, examples of the benzyl methyl ketal photoradical polymerization initiator include 2,2′-dimethoxy-1,2-diphenylethane-1-one (IRGACURE (trademark) 651, manufactured by BASF), examples of the α-hydroxyalkylphenone photoradical polymerization initiator include 2-hydroxy-2-methyl-1-phenylpropan-1-one (DAROCUR (trademark) 1173, manufactured by BASF), 1-hydroxycyclohexyl phenyl ketone (IRGACURE (trademark) 184, manufactured by BASF), 1-[4-(2-hydroxyethoxy) phenyl]-2-hydroxy-2-methyl-1-propan-1-one (IRGACURE (trademark) 2959, manufactured by BASF), and 2-hydroxy-1-{4-[4-(2-hydroxy-2-methylpropionyl) benzyl] phenyl}-2-methylpropan-1-one (IRGACURE (trademark) 127, manufactured by BASF), and examples of the aminoalkylphenone photoradical polymerization initiator include 2-methyl-1-(4-methylthiophenyl)-2-morpholinopropan-1-one (IRGACURE (trademark) 907, manufactured by BASF) or 2-benzylmethyl-2-dimethylamino-1-(4-morpholinophenyl)-1-butanone (IRGACURE (trademark)369, manufactured by BASF); however, examples thereof are not limited thereto. Examples of the acyl phosphine oxide photoradical polymerization initiator include 2,4,6-trimethyl benzoyl diphenyl phosphine oxide (LUCIRIN (trademark) TPO, manufactured by BASF) and bis(2,4,6-trimethylbenzoyl)-phenyl phosphine oxide(IRGACURE (trademark) 819, manufactured by BASF); however, examples thereof are not limited thereto. Examples of the oxime ester photoradical polymerization initiator include (2E)-2-(benzoyloxyimino)-1-[4-(phenylthio) phenyl] octan-1-one (IRGACURE (trademark) OXE-01, manufactured by BASF); however, examples thereof are not limited thereto.

Examples of the hydrogen abstraction type photoradical polymerization initiator include anthraquinone derivatives such as 2-ethyl-9,10-anthraquinone and 2-t-butyl-9,10-anthraquinone, and thioxanthone derivatives such as isopropyl thioxanthone and 2,4-diethyl thioxanthone; however, examples thereof are not limited thereto.

In the present disclosure, two or more types of the radical polymerization initiator may be used in combination. In addition, the radical polymerization initiator may be used alone. Moreover, in order to advance a polymerization reaction by the heat treatment after molding, the thermal radical polymerization initiator may be contained.

The additional amount of the photoradical polymerization initiator is preferably 0.1 parts by mass or more and 15 parts by mass or less, and is more preferably 0.1 parts by mass or more and 10 parts by mass or less, relative to 100 parts by mass of all radical polymerizable compounds in the curable resin composition. If the amount of the photoradical polymerization initiator is small, polymerization tends to be insufficient. If the amount of the photoradical polymerization initiator is large, the light transmittance may be reduced, and the polymerization may be nonuniform.

(Thermal Radical Polymerization Initiator)

The thermal radical polymerization initiator is not particularly limited as long as it generates radicals by heating, and it is possible to use conventionally known compounds. For example, an azo compound, peroxides, a persulfate, and the like can be exemplified as preferable ones. Examples of the azo compound include 2,2′-azobisisobutyronitrile, 2,2′-azobis (methyl isobutyrate), 2,2′-azobis-2,4-dimethyl valeronitrile, and 1,1′-azobis (1-acetoxy-1-phenylethane). Examples of the peroxide include benzoyl peroxide, di-t-butyl benzoyl peroxide, t-butyl peroxy pivalate, and di (4-t-butylcyclohexyl) peroxydicarbonate. Examples of persulfate include persulfate such as ammonium persulfate, sodium persulfate, and potassium persulfate.

The additional amount of the thermal radical polymerization initiator is preferably 0.1 parts by mass or more and 15 parts by mass or less, and is more preferably 0.1 parts by mass or more and 10 parts by mass or less, relative to 100 parts by mass of all radical polymerizable compounds in the curable resin composition. If the amount of the thermal radical polymerization initiator is small, polymerization tends to be insufficient.

[Anionic Polymerization Initiator]

In a case where the anionic polymerizable compound as a reactive diluent (D) to be described later is added to the curable resin composition of the present disclosure, an anionic polymerization initiator can be used. As the anionic polymerization initiator, a photobase generator can be used.

(Photobase Generator)

The photobase generator refers to a compound that generates a base by irradiation of energy rays such as ultraviolet light and visible light. In particular, a salt containing borate anion is preferable due to the excellent sensitivity to the light. Specific examples of the product include U-CAT5002 manufactured by San-Apro Ltd. and P3B, BP3B, N3B, and MN3B manufactured by SHOWADENKO K.K., but examples thereof are not limited thereto.

The additional amount of the anionic polymerization initiator is preferably 0.1 parts by mass or more and 15 parts by mass or less, and is more preferably 0.1 parts by mass or more and 10 parts by mass or less, relative to 100 parts by mass of the total of anionic polymerizable compound. If the amount of the anionic polymerization initiator is small, polymerization tends to be insufficient.

[Other Curing Agents]

The following thermal latent curing agent can be used in the curable resin composition of the present disclosure. The thermal latent curing agent refers to a curing agent that causes heat curing to proceed by overheating.

As the acid anhydrides (acid anhydride curing agent), known or conventional acid anhydride curing agents can be used, and is not particularly limited. Examples thereof include methyltetrahydrophthalic anhydride (4-methyltetrahydrophthalic anhydride, 3-methyltetrahydrophthalic anhydride, and the like), methylhexahydrophthalic anhydride (4-methylhexahydrophthalic anhydride, 3-methylhexahydrophthalic anhydride, and the like), dodecenyl succinic anhydride, methyl endo methylene tetrahydrophthalic anhydride, phthalic anhydride, maleic anhydride, tetrahydrophthalic anhydride, hexahydrophthalic anhydride, methylcyclohexene dicarboxylic anhydride, pyromellitic anhydride, trimellitic anhydride, benzophenone tetracarboxylic anhydride, nadic anhydride, methyl nadic anhydride, hydrogenated methyl nadic anhydride, 4-(4-methyl-3-pentenyl) tetrahydrophthalic anhydride, succinic anhydride, adipic anhydride, sebacic anhydride, dodecanedioic anhydride, methylcyclohexene tetracarboxylic acid anhydride, a vinyl ether-maleic anhydride copolymer, and an alkylstyrene-maleic anhydride copolymer. Among them, acid anhydride (for example, methyltetrahydrophthalic anhydride, methylhexahydrophthalic anhydride, dodecenyl succinic anhydride, and methyl endo methylene tetrahydrophthalic anhydride) which is liquid at 25° C. is preferable from the viewpoint of handleability. On the other hand, regarding a solid acid anhydride at 25° C., for example, there is a tendency that the handleability of the curable resin composition of the present disclosure is improved by dissolving in a liquid acid anhydride at 25° C. to form a liquid mixture. From the viewpoint of heat resistance and transparency of the cured product, as the acid anhydride curing agent, anhydrides of saturated monocyclic hydrocarbon dicarboxylic acids (including those in which a substituent such as an alkyl group is bonded to a ring) are preferable.

As amines (amine curing agents), known or conventional amine curing agents can be used, and is not particularly limited. Examples thereof include aliphatic polyamine such as ethylenediamine, diethylenetriamine, triethylenetetramine, tetraethylenepentamine, dipropylenediamine, diethylaminopropylamine, and polypropylenetriamine; alicyclic polyamine such as mensene diamine, isophorone diamine, bis(4-amino-3-methyldicyclohexyl) methane, diaminodicyclohexylmethane, bis(aminomethyl) cyclohexane, N-aminoethyl piperazine, and 3,9-bis(3-aminopropyl)-3,4,8,10-tetraoxaspiro [5,5] undecane; mononuclear polyamine such as m-phenylenediamine, p-phenylenediamine, tolylene-2,4-diamine, tolylene-2,6-diamine, mesitylene-2,4-diamine, 3,5-diethyltolylene-2,4-diamine, and 3,5-diethyltolylene-2,6-diamine; and aromatic polyamines such as biphenylenediamine, 4,4-diaminodiphenylmethane, 2,5-naphthylenediamine, and 2,6-naphthylenediamine.

As phenols (phenolic curing agent), known or conventional phenolic curing agents can be used, and is not particularly limited. Examples thereof include an aralkyl resin such as a novolac type phenol resin, a novolac type cresol resin, a paraxylylene modified phenolic resin, and a paraxylylene/metaxylylene modified phenolic resin, a terpene-modified phenolic resin, a dicyclopentadiene-modified phenolic resin, and a triphenolpropane.

Examples of the polyamide resin include a polyamide resin having any one or both of a primary amino group and a secondary amino group in a molecule.

As imidazoles (imidazole-based curing agent), known or conventional imidazole curing agents can be used, and is not particularly limited. Examples thereof include 2-methylimidazole, 2-ethyl-4-methylimidazole, 2-undecylimidazole, 2-heptadecylimidazole, 2-phenylimidazole, 1-benzyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-undecylimidazolium trimellitate, 1-cyanoethyl-2-phenylimidazolium trimellitate, 2-methylimidazolium isocyanurate, 2-phenylimidazolium isocyanurate, 2,4-diamino-6-[2-methylimidazolyl-(1)]-ethyl-s-triazine, and 2,4-diamino-6-[2-ethyl-4-methylimidazolyl-(1)]-ethyl-s-triazine.

Examples of polymercaptans (polymercaptan curing agent) include liquid polymercaptans and a polysulfide resin.

Examples of polycarboxylic acids include adipic acid, sebacic acid, terephthalic acid, trimellitic acid, and carboxy group-containing polyester.

The additional amount of other curing agents is preferably 0.1 parts by mass or more and 75 parts by mass or less, and is more preferably 5 parts by mass or more and 30 parts by mass or less, relative to 100 parts by mass of the total of anionic polymerizable compound. If the additional amount of the other curing agents is small, the polymerization tends to be insufficient, and if the additional amount is excessively large, there is a tendency that the crosslinking reaction proceeds to cause deterioration of toughness.

<Other Components>

[Reactive Diluent (D)]

The curable resin composition according to the present disclosure may contain a reactive diluent (D) in addition to a cationic polymerizable compound (A), an inorganic particle (B), and a curing agent (C). The viscosity of a curable composition can be reduced by containing the reactive diluent (D) in the curable resin composition. In addition, mechanical properties and thermal properties of a cured product obtained by curing the curable composition can be adjusted. The reactive diluent (D) can be added with a monomer having radical polymerization property, cation polymerization property, or anion polymerization property.

Examples of a monomer having radical polymerization property include a (meth)acrylate monomer, a styrenic monomer, an acrylonitrile compound, a vinyl ester monomer, an N-vinylpyrrolidone, an acrylamide based monomer, a conjugated diene monomer, a vinyl ketone monomer, and a halogenated vinyl and vinylidene halide monomer. Examples of a monomer having cationic polymerization property include an epoxy monomer, an oxetane monomer, and a vinyl ether monomer. Examples of a monomer having anionic polymerization property include a (meth)acrylate monomer; however, examples thereof are not limited thereto. Among them, the monomer having cationic polymerization property reacts by the same kind of mechanism as the cationic polymerizable compound (A), and thus is particularly preferable from the viewpoint of the reaction rate. In addition, the reactive diluent (D) preferably includes the monomer having radical polymerization property in order to reduce coefficient of the cured product.

The reactive diluent (D) can be used by optionally mixing one or more kinds thereof. The additional amount of the reactive diluent (D) is preferably 50 parts by mass or less and more preferably 25 parts by mass or less relative to 100 parts by mass of cationic polymerizable compound (A). In a case where the amount of the reactive diluent (D) exceeds 50 parts by mass, the effects of the present disclosure may be impaired.

<Additives>

In the curable resin composition of the present disclosure, various additives may be contained as other optional components, as long as the aspects and effects of the present disclosure are not impaired. As such additives, a resin filler such as a cured epoxy resin, polyurethane, polybutadiene, polychloroprene, polyester, a styrene-butadiene block copolymer, polysiloxane, a petroleum resin, a xylene resin, a ketone resin, and a cellulose resin, an engineering plastic filler such as polycarbonate, modified polyphenylene ether, polyamide, polyacetal, polyethylene terephthalate, polybutylene terephthalate, ultra-high molecular weight polyethylene, polyphenylsulfone, polysulfone, polyarylate, polyetherimide, polyether ether ketone, polyphenylene sulfide, polyether sulfone, polyamide imide, Liquid a crystalline polymer, polytetrafluoroethylene, polychlorotrifluoroethylene, and polyvinylidene fluoride, or an inorganic filler of compounds such as soft metals such as gold, silver, lead and aluminum, silica, titania, alumina.

Examples thereof further include a polymerization inhibitor such as phenothiazine, 2,6-di-t-butyl-4-methylphenol, a photosensitizer such as a benzoin compound, an acetophenone compound, an anthraquinone compound, a thioxanthone compound, a ketal compound, a benzophenone compound, a tertiary amine compound, and a xanthone compound, a polymerization start auxiliary agent, a leveling agent, a wettability improver, a surfactant, a plasticizer, a UV absorber, an inorganic filler, a pigment, a dye, an antioxidant, a flame retardant, a thickener, and an antifoamer.

In addition, a reactive monomer such as a fluorinated oligomer, a silicone oligomer, a polysulfide oligomer, a fluorine-containing monomer, and a siloxane structure containing monomer, and a silane coupling agent may be added.

<Light Transmittance of Curable Resin Composition>

The light transmittance of the curable resin composition is 0.1% or more. The light transmittance is a value obtained by dividing the intensity of the transmitted light when the resin composition is irradiated with light by the intensity of the irradiated light, and includes the forward scattering. The intensity of the transmitted light is obtained by combining the light transmitted without absorption when irradiating the curable resin composition having a thickness of 200 μm with irradiated light having a wavelength of 365 nm or 405 nm, and the light scattered forward to the light source. If the light transmittance is 0.1% or more, the resin composition can be cured by light irradiation of a three-dimensional molding machine. The higher the light transmittance, the shorter the light irradiation time required for curing and the faster the curing speed, and thus the light transmittance is more preferably 1% or more, and still more preferably 10% or more.

<Curable Resin Composition>

The curable resin composition of the present disclosure can be prepared by putting the cationic polymerizable compound (A), the inorganic particle (B), and the curing agent (C), which are essential components, and if necessary, other optional components, into a stirring container, and stirring generally at 30° C. or higher and 120° C. or lower, and preferably 50° C. or higher and 100° C. or lower. The stirring time at that time is generally 1 minute or more and 6 hours or less, and preferably 10 minutes or more and two hours or less.

The content of a total of the cationic polymerizable compound (A) and the inorganic particle (B) (in a case of containing the reactive diluent (D), the total of the cationic polymerizable compound (A), the inorganic particle (B), and the reactive diluent (D)) is preferably 1 parts by mass or more and 100 parts by mass or less, more preferably 25 parts by mass or more and 100 parts by mass or less, and still more preferably 75 parts by mass or more and 100 parts by mass or less, relative to 100 parts by mass of the curable resin composition except for the curing agent (C). With this, it is possible to efficiently obtain the effects of the present disclosure.

The viscosity of the curable resin composition of the present disclosure at 25° C. is preferably 50 mPa·s or more and 10,000 mPa·s or less, and is more preferably 70 mPa·s or more and 5,000 mPa·s or less.

The curable resin composition of the present disclosure obtained as described above is suitably used as a photocurable resin composition in the optical three-dimensional molding method. That is, a three-dimensional molded product in a desired shape can be produced by an optical three-dimensional molding method in such a manner that the curable resin composition of the present disclosure is selectively irradiated with active energy rays such as ultraviolet rays, electron beams, X-rays, and radiation, and supplied with energy required for curing.

<Cured Product>

In the curable resin composition of the present disclosure, the cationic polymerizable compound (A), the inorganic particle (B), and the curing agent (C) are essential components, and a cured product can be obtained by curing these. As a curing method, in accordance with the curing agent to be contained, any known method such as active energy ray curing or heat curing can be used. A plurality of curing methods may be combined.

<Function of Curable Resin Composition>

The curable resin composition of the present disclosure contains, as an essential component, an inorganic particle (B) having a layered crystal structure. As a feature of the compound having a layered crystal structure, layers in flush with each other are strongly connected by covalent bonds, but the layers are bonded by weak van der Waals force. For this reason, it has slippery properties in the parallel direction while having high mechanical strength in the direction perpendicular to the direction of the layer.

In addition, since the cured product of the curable resin composition of the present disclosure can be cured without causing aggregation or separation of the inorganic particles (B) during curing, the inorganic particles (B) having a layered crystal structure are also present on the outermost surface. As a result, the cured product of the curable resin composition of the present disclosure can provide a cured product having a lower coefficient of dynamic friction and the abrasion resistance than ever before.

The curable resin composition of the present disclosure contains, as an essential component, a cationic polymerizable compound (A) having an elastic modulus of 2.0 GPa or more after curing. Not only the higher the elastic modulus, the higher the abrasion resistance, but also the progress of abrasion (ternary abrasive wear) by abrasion powder containing the inorganic particle (B) can be suppressed, and thus it is possible to provide a cured product that is superior in the abrasion resistance to the related art.

In addition, since the inorganic particle (B) hardly causes volume shrinkage before and after curing, the shrinkage during the curing can be suppressed by the amount of the volume contained in the curable resin composition. Furthermore, in a case where an epoxy compound with small shrinkage during the curing is selected as the cationic polymerizable compound (A), the shrinkage during the curing can be further suppressed together with the effect of the inorganic particle (B) described above. That is, in a case of being used as a curable resin composition for three-dimensional molding, it is possible to provide a curable resin composition having a molding accuracy higher than that in the related art.

<Method of Producing Three-Dimensional Molded Product>

The curable resin composition of the present disclosure can be suitably used for an optical three-dimensional molding method by containing a photopolymerization initiator such as a photocationic polymerization initiator as a curing agent (C). The cured product of the curable resin composition may be produced using any of known optical three-dimensional molding methods and apparatuses in the related art. A representative example of the preferable optical three-dimensional molding method is a method including a step of curing the curable resin composition layer by layer based on slice data to mold a molded product. Specifically, the curable resin composition in a liquid state is selectively irradiated with active energy rays based on slice data to form a cured layer so that a cured layer having a desired pattern can be obtained. Then, an uncured curable resin composition is supplied to the cured layer, and similarly, the curable resin composition is irradiated with the active energy rays based on the slice data to newly form a cured layer continuous with the above-described cured layer. A method of finally obtaining a desired three-dimensional molded product by repeating this laminating operation can be exemplified.

As the active energy rays at that time, ultraviolet rays, electron beams, X-rays, radiation, and the like can be exemplified. Among them, ultraviolet light having a wavelength of 300 nm or more and 450 nm or less is preferably used from the economical viewpoint. As a light source at that time, ultraviolet laser (for example, Ar laser and He—Cd laser), a mercury lamp, an xenon lamp, a halogen lamp, a fluorescent lamp, and the like can be used. Among them, a laser light source can increase an energy level and shorten a molding time, is excellent in the light collecting properties to obtain high molding accuracy, and thus is preferably employed.

In forming each cured resin layer having a predetermined shape pattern by irradiating a molded surface made of a curable resin composition with the active energy rays, the cured resin layer may be formed in a stippling or drawing manner using the active energy rays narrowed in a spot shape such as laser light. In addition, a molding method of forming a cured resin layer by planarly irradiating the molded surface with the active energy rays through a planar drawing mask formed by arranging a plurality of micro light shutters such as a liquid crystal shutter or a digital micro mirror shutter may be adopted.

The following is a typical example of optical three-dimensional molding method. First, a support stage provided to be movable up and down in a storage container is made to drop by a minute amount (sedimentation) from a liquid surface of the curable resin composition so that the curable resin composition is supplied onto the support stage to form a thin layer (1). Then, the thin layer (1) is selectively irradiated with light to form a solid cured resin layer (1). Then, a curable resin composition is supplied onto the cured resin layer (1) to form a thin layer (2), and the thin layer (2) is selectively irradiated with light to form a new cured resin layer (2) on the cured resin layer (1) so as to be continuously and integrally laminated thereon. By repeating this process a predetermined number of times while changing or not changing the pattern to be irradiated with light, a three-dimensional molded product obtained by integrally laminating a plurality of cured resin layers (1, 2, . . . n) is molded.

The three-dimensional molded product obtained in this manner is taken out from the storage container, and washed if necessary, after removing the unreacted curable resin composition remaining on the surface. Here, examples of a cleaning agent include an alcohol organic solvent represented by alcohols such as isopropyl alcohol, ethyl alcohol, and the like; a ketone organic solvent represented by acetone, ethyl acetate, methylethyl ketone, and the like; an aliphatic organic solvent represented by terpenes. After cleaning with the cleaning agent, post curing may be performed by light irradiation or heat irradiation, if necessary. In the post curing, it is possible to cure the unreacted curable resin composition that may remain on the surface and inside of the three-dimensional molded product, and to suppress stickiness on the surface of the molded product. The initial strength of the molded product can be improved as well.

<Applications>

The application of the curable resin composition according to the present disclosure and the cured product thereof is not particularly limited. For example, it can be used for various applications such as resins for 3D printer using an optical molding method, sports goods, medical and nursing care goods, industrial machines and devices, precision instruments, electric and electronic equipment, electric and electronic parts, and building materials.

### EXAMPLES

The present disclosure will be described in detail by way of the following examples, but the present invention is not limited to these examples.

### Examples 1 to 10 and Comparative Examples 1 to 6

[Preparation of Composition]

Each component was compounded according to the formulation indicated in Table 1, heated at 75° C., and stirred for two hours with a stirrer to prepare a curable resin composition.

(Cationic Polymerizable Compound (A))

A1: Bifunctional alicyclic epoxy compound (3′,4′-epoxycyclohexylmethyl 3,4-epoxycyclohexane carboxylate, “Ceroxide 2021P” manufactured by Daicel Corporation)

A2: Bifunctional alicyclic epoxy compound (ε-caprolactone modified 3′,4′-epoxycyclohexylmethyl 3,4-epoxycyclohexane carboxylate, “Ceroxide 2081” manufactured by Daicel Corporation)

A3: Bifunctional non-alicyclic epoxy compound (“EXA-4816” manufactured by DIC)

A4: Mixture of trifunctional non-alicyclic epoxy compound and bifunctional oxetane compound (“KEA-21” manufactured by KSM Co., Ltd)

A5: Bifunctional non-alicyclic epoxy compound (“EXA-4850-1000” manufactured by DIC)

A6: Bifunctional non-alicyclic epoxy compound (“EXA-4850-150” manufactured by DIC)

(Inorganic particle (B))

B1: Graphite fluoride (“Cefbon CMC” manufactured by Central Glass Co., Ltd.)

B2: Boron nitride (manufactured by Sigma-Aldrich Co. LLC)

B3: Silicon nitride (trade name “HM-5MF” manufactured by NTK CERATEC CO., LTD.)

B4: Graphite (trade name “Z-5F” manufactured by Ito Graphite Co., Ltd.)

(Curing Agent (C))

C1: Photocationic polymerization initiator (“CPI-210S” (manufactured by San-Apro Ltd.))

C2: Photocationic polymerization initiator (“Irgacure 184” (manufactured by BASF))

(Other Components)

D1: Mixture of 40 mass % of trifunctional urethane acrylate compound (“UV7550B” manufactured by The Nippon Synthetic Chemical Industry Co., Ltd), 30 mass % of monofunctional urethane acrylate compound (“Isobornyl Acrylate” manufactured by Tokyo Chemical Industry Co., Ltd), and 30 mass % of monofunctional acrylate amide compound (“ACMO” manufactured by KJ Chemicals Co.)

D2: Mixture of 40 mass % of difunctional urethane acrylate compound (“UV6630B” manufactured by The Nippon Synthetic Chemical Industry Co., Ltd), 2.5 mass % of difunctional urethane acrylate compound (“A-DCP” manufactured by Shin-Nakamura Chemical Co., Ltd), 20 mass % of maleimide compound having radical polymerization property (“ACMO” manufactured by KJ Chemicals Co.), and 37.5 mass % of monofunctional acrylate amide compound (“ACMO” manufactured by KJ Chemicals Co.)

Silica (trade name “Admafine SO-E6” manufactured by Admatechs)

[Production of Test Piece]

A test piece was produced by the following method from the prepared curable resin composition. First, a mold having a length of 80 mm, a width of 10 mm, and a thickness of 4 mm was sandwiched between two quartz glasses, and the curable resin composition was poured into the mold. The poured curable resin composition was irradiated with ultraviolet light of 5 mW/cm² from both sides of the mold for 120 seconds by an ultraviolet irradiator (product name “LIGHT SOURCE EXECURE 3000”, manufactured by HOYA CANDEO OPTRONICS) to perform temporary curing. Thereafter, main curing was performed by irradiating the curable resin composition with ultraviolet light from the both sides again for 360 seconds to obtain a cured product (in total energy of 4800 mJ/cm²). The obtained cured product was put in a heating oven at 50° C. and subjected to a heat treatment for one hour in the heating oven at 100° C. for two hours so as to obtain a test piece having a length of 80 mm, a width of 10 mm, and a thickness of 4 mm.

[Production of Test Film]

A test film was produced by the following method from the prepared curable resin composition. First, several drops of the curable resin composition were placed on the center of a slide glass having a width of 26 mm, a length of 76 mm, and a thickness of about 1 mm, and a spacer having a thickness of 300 μm was installed on both ends of the slide glass. Next, a film made of PET was placed on the dropped curable resin composition, and the slide glass was placed thereon. Thereafter, the dropped curable resin composition was irradiated with ultraviolet light of 5 mW/cm² for 300 seconds (total energy of 1500 mJ/cm²) with an ultraviolet light irradiator (product name “UV LIGHT SOURCE EX 250”, manufactured by HOYA-SCHOTT). Next, the PET film was peeled off, and the obtained cured product was put in the heating oven at 50° C., put in the heating oven at 100° C. for one hour, and subjected to a heat treatment for two hours so as to obtain a test film closely attached to a slide glass having a thickness of 300 μm and a diameter of about 2 cm.

[Evaluation]

(Light Transmittance of Curable Resin Composition)

The light transmittance of the curable resin composition was measured as follows. Further, several drops of the prepared curable resin composition were placed on the center of a slide glass having a width of 26 mm, a length of 76 mm, and a thickness of about 1 mm, and a spacer having a thickness of 200 μm was installed on both ends of the slide glass. Next, a slide glass having the same type was placed on the dropped curable resin composition, and a curable resin composition having a thickness of 200 μm was prepared. Next, the transmittance at 365 nm and 405 nm of the curable resin composition having a thickness of 200 μm was measured using an ultraviolet-visible spectrophotometer (product name “SOLIC SPEC-3700”, manufactured by Shimadzu Corporation). The term “transmitted light” as used herein refers to the combined intensity of the light transmitted without being absorbed and the light scattered forward to the light source, and was measured using an integrating sphere. The obtained results are indicated in Table 1.

(Flexural Modulus)

The cationic polymerizable compound (A) and the curing agent (C) were separately prepared, and a test piece was produced by the above method to produce a sample for a bending test. The test piece was subjected to a three-point bending test (conditions: test speed: 2 mm/min, distance between supporting points: 64 mm, radius of indenter: 5 mm, and radius of support: 5 mm) using a tensile and compression tester (product name “Tensilon universal material test instrument RTF-1250C”, manufactured by A&D Company, Limited), and the flexural modulus was calculated from a stress gradient of 0.05% to 0.25% in measured distortion interval. The obtained results are indicated in Table 1.

(Molding Accuracy)

A cure shrinkage rate was used as an index of molding accuracy. The cure shrinkage rate was a value obtained by dividing the difference in specific gravity of the cured product and the curable resin composition by the specific gravity of the cured product. The criteria of the molding accuracy by the cure shrinkage rate are indicated below. Also, the obtained results are indicated in Table 1.

A: less than 2.0%

B: 2.0% or more and less than 2.5%

C: 2.5% or more

(Slidability)

A coefficient of dynamic friction was used as an index of slidability. The coefficient of dynamic friction was measured using an abrasion/friction tester (product name: HEIDON Type 20, manufactured by Shinto Scientific Co., Ltd.). The test film was fixed to a rotary stage, and a ball of SUS304 having a diameter of 10 mm was abutted so as to set a sliding radius to 5 mm. A vertical load of 100 g was applied to the ball, the stage was rotated at a speed of 10 cm/sec, and the force applied between the test film and the SUS304 ball was measured. The coefficient of dynamic friction was calculated by dividing the applied force by the load. During a total three hours of measurement, an average value excluding the first five minutes was set as a coefficient of dynamic friction. The criteria of the slidability by the coefficient of dynamic friction are indicated below. Also, the obtained results are indicated in Table 1.

A: less than 0.45

B: 0.45 or more and less than 0.55

C: 0.55 or more

(Abrasion Resistance)

A specific abrasion amount was used as an index of abrasion resistance. The specific abrasion amount was calculated by the following method from a sliding trace of the resin after the above-described measurement of the coefficient of dynamic friction. First, the sliding trace after measuring the coefficient of dynamic friction was used to determine an abrasion cross-sectional area with a confocal microscope (OPTELICS C130, manufactured by Lasertec Corporation), and a value obtained by multiplying the circumferential length was set as an abrasion volume. Next, the value obtained by dividing the obtained abrasion volume by the load and the sliding distance was set as a specific abrasion amount. The criteria of the abrasion resistance by the specific abrasion amount are indicated below. Also, the obtained results are indicated in Table 1.

A: less than 0.02 mm³/N·Km

B: 0.02 mm³/N·Km or more and less than 0.05 mm³/N·Km

C: 0.05 mm³/N·Km or more

TABLE 1

| | Component (A) | | | | | | | | |
|---|---|---|---|---|---|---|---|---|---|
| | | | Flexural | Component (B) | | Component (C) | | Other components | |
| | | Content | modulus | | Content | | Content | | Content |
| | Kinds | [Part by mass] | [GPa] | Kinds | [Part by mass] | Kinds | [Part by mass] | Kinds | [Part by mass] |
| Example 1 | A1 | 80 | 3.4 | B1 | 20 | C1 | 1.6 | — | 0 |
| Example 2 | A2 | 80 | 2.4 | B1 | 20 | C1 | 1.6 | — | 0 |
| Example 3 | A1 | 80 | 3.4 | B2 | 20 | C1 | 1.6 | — | 0 |
| Example 4 | A1 | 80 | 3.4 | B3 | 20 | C1 | 1.6 | — | 0 |
| Example 5 | A1 | 90 | 3.4 | B1 | 10 | C1 | 1.8 | — | 0 |
| Example 6 | A1 | 70 | 3.4 | B1 | 30 | C1 | 1.4 | — | 0 |
| Example 7 | A3:A4 = | 80 | 2.0 | B1 | 20 | C1 | 1.6 | — | 0 |
| | 70:30 | | | | | | | | |
| | (Mass ratio) | | | | | | | | |
| Example 8 | A5 | 80 | 2.0 | B1 | 20 | C1 | 1.6 | — | 0 |
| Example 9 | A1 | 75 | 3.4 | B1 | 25 | C1:C2 = | 1.9 | D1 | 20 |
| | | | | | | 80:20 | | | |
| Example 10 | A1 | 75 | 3.4 | B1 | 25 | C1:C2 = | 1.9 | D2 | 20 |
| | | | | | | 80:20 | | | |
| Comparative | A1 | 100 | 3.4 | — | 0 | C1 | 2.0 | — | 0 |
| Example 1 | | | | | | | | | |
| Comparative | A1 | 95 | 3.4 | B1 | 5 | C1 | 1.9 | — | 0 |
| Example 2 | | | | | | | | | |
| Comparative | A1 | 60 | 3.4 | B1 | 40 | C1 | 1.2 | — | 0 |
| Example 3 | | | | | | | | | |
| Comparative | A1 | 80 | 3.4 | — | 0 | C1 | 1.6 | Silica | 20 |
| Example 4 | | | | | | | | | |
| Comparative | A6 | 80 | 1.6 | B1 | 20 | C1 | 1.6 | — | 0 |
| Example 5 | | | | | | | | | |
| Comparative | A1 | 80 | 3.4 | B4 | 20 | C1 | 1.6 | — | 0 |
| Example 6 | | | | | | | | | |

| | | | Molding | | | | | |
|---|---|---|---|---|---|---|---|---|
| | | | accuracy | | | | Abrasion | |
| | Light transmittance | | | Cure | Slidability | | resistance | |
| | of resin composition | | | shrinkage | | Coefficient of | | Specific |
| | [%] | | | rate | | dynamic | | abrasion amount |
| | 365 nm | 405 nm | Evaluation | [%] | Evaluation | friction | Evaluation | [mm3/N · Km] |
| Example 1 | 49.0 | 59.0 | B | 2.1 | A | 0.42 | A | 0.002 |
| Example 2 | 55.0 | 63.0 | A | 1.9 | A | 0.43 | A | 0.019 |
| Example 3 | 1.8 | 6.7 | B | 2.1 | B | 0.47 | B | 0.023 |
| Example 4 | 0.1 | 0.1 | B | 2.1 | B | 0.52 | A | 0.003 |
| Example 5 | 76.0 | 89.0 | B | 2.4 | B | 0.45 | B | 0.026 |
| Example 6 | 26.0 | 30.0 | A | 1.8 | A | 0.41 | B | 0.034 |
| Example 7 | 44.0 | 49.0 | B | 2.0 | B | 0.54 | B | 0.047 |
| Example 8 | 41.0 | 49.0 | B | 2.0 | B | 0.48 | B | 0.049 |
| Example 9 | 48 | 62 | B | 2.4 | A | 0.34 | B | 0.021 |
| Example 10 | 25 | 55 | B | 2.4 | A | 0.38 | B | 0.027 |
| Comparative | 91.0 | 100.0 | C | 2.6 | C | 0.61 | C | 0.106 |
| Example 1 | | | | | | | | |
| Comparative | 86.0 | 95.0 | C | 2.6 | B | 0.47 | C | 0.079 |
| Example 2 | | | | | | | | |
| Comparative | 11.0 | 15.0 | A | 1.6 | A | 0.41 | C | 0.069 |
| Example 3 | | | | | | | | |
| Comparative | 9.1 | 10.0 | B | 2.0 | C | 0.56 | C | 0.077 |
| Example 4 | | | | | | | | |
| Comparative | 43.0 | 47.0 | B | 2.0 | B | 0.49 | C | 0.251 |
| Example 5 | | | | | | | | |

| | | | | | |
|---|---|---|---|---|---|
| Comparative | 0 | 0 | Curing failure | Curing failure | Curing failure |
| Example 6 | | | | | |

As indicated in Table 1, in all cases of Examples 1 to 8 according to the present disclosure, the cure shrinkage rate is less than 2.5%, the coefficient of friction is less than 0.55, and the specific abrasion amount is less than 0.05 mm³/N·Km, and therefore, it was possible to obtain a cured product compatible with excellent molding accuracy, high slidability, and high abrasion resistance.

On the other hand, the additional amount of the inorganic particles (B) has a preferable range, and in Comparative Examples 1 to 3 outside the preferable range, there were some items that could not exceed a target lever of the evaluation. From these results, it was suggested that the inorganic particle (B) was effective in improving the molding accuracy, the slidability, and the abrasion resistance; however, when the additional amount was excessively large, the abrasion resistance was significantly deteriorated. It is presumed that this is because the interface with the cationic polymerizable compound (A) increases as the additional amount of the inorganic particles (B) increases, thereby inducing fatigue abrasion.

In addition, in Comparative Example 4 in which silica, which is an inorganic particle having no layered crystal structure, was added, improvement in the molding accuracy was observed, but improvement in the slidability and the abrasion resistance was not observed. From these results, it was suggested that the inorganic particle has a layered crystal structure, which is effective in improving the slidability and the abrasion resistance.

Further, in Comparative Example 5 in which the flexural modulus after curing the cationic polymerizable compound (A) is less than 2.0 GPa, the abrasion resistance was significantly deteriorated even though the inorganic particle (B) having a layered crystal structure was added in a preferable range. This is assumed that the abrasion powder containing the inorganic particle (B) contributes to the abrasion of the cured product of the cationic polymerizable compound (A). This phenomenon is generally referred to as ternary abrasive wear. According to the result of Table 1, particularly from the results of Examples 1 and 8 and Comparative Example 5, the abrasion resistance is high as the elastic modulus of the cationic polymerizable component (A) of the resin components is high, and therefore, it was suggested that the elastic modulus of the cationic polymerizable compound (A) is preferably high so as to prevent the ternary abrasive wear.

On the other hand, as indicated in Examples 1, 2, 7, and 10 and Comparative Example 5, the modulus of elasticity of the cationic polymerizable compound (A) after curing was higher for the alicyclic epoxy. This is assumed to be due to the introduction of a rigid alicyclic alkyl group into a polyethylene glycol chain formed after ring-opening cationic polymerization of an epoxy compound. From this result, it was suggested that an alicyclic epoxy compound is preferable as the cationic polymerizable compound.

In addition, as indicated in Examples 9 and 10, the examples using compounds having radical polymerization property as other components (the reactive diluent (D)) showed decrease of coefficient of friction of the cured product in compare with the examples not using compounds having radical polymerization property. It is assumed that the coefficient of friction of the cured product was decreased because coefficient of friction of the compounds having radical polymerization property is small. As the results of these Examples, is it preferred that the curable resin composition include a compound having radical polymerization property as other components (the reactive diluent (D)) in order to decrease coefficient of friction of the cured product.

In Comparative Example 6 in which the light transmittance at 365 nm and 405 nm was 0%, curing failure occurred and thus it was not possible to perform the evaluation. On the other hand, Example 4 having a light transmittance of 0.1% was curable to be evaluated. From these results, it was suggested that the light transmittance of 0.1% or more is preferable as the curable resin composition.

The curable resin composition for three-dimensional molding of the present disclosure can provide a cured product with high molding accuracy, low coefficient of friction, and high abrasion resistance.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-170181, filed Sep. 12, 2018, and Japanese Patent Application No. 2019-145162, filed Aug. 7, 2019, which are hereby incorporated by reference herein in their entirety.

What is claimed is:

1. A curable resin composition for three-dimensional molding, comprising:
a cationic polymerizable compound (A);
an inorganic particle (B); and
a curing agent (C),
wherein a flexural modulus of a cured product obtained by polymerizing a composition consisting of the cationic polymerizable compound (A) and the curing agent (C) is 2.0 GPa or more,
the inorganic particle (B) has a layered crystal structure, a content of the inorganic particle (B) is 10 parts by mass or more and 30 parts by mass or less, relative to total 100 parts by mass of the cationic polymerizable compound (A) and the inorganic particle (B), and
the curable resin composition having a thickness of 200 μm has a light transmittance including forward scattering of 0.1% or more at a wavelength of 365 nm or 405 nm.

2. The curable resin composition for three-dimensional molding according to claim 1,
wherein a content of the curing agent (C) is 0.1 parts by mass or more and 15 parts by mass or less relative to 100 parts by mass of the cationic polymerizable compound (A).

3. The curable resin composition for three-dimensional molding according to claim 2,
wherein the flexural modulus of the cured product obtained by polymerizing the composition consisting of the cationic polymerizable compound (A) and the curing agent (C) is 3.0 GPa or more.

4. The curable resin composition for three-dimensional molding according to claim 1,
wherein the inorganic particle (B) is selected from the group consisting of graphite fluoride, boron nitride, and silicon nitride.

5. The curable resin composition for three-dimensional molding according to claim 4,
wherein the light transmittance is 1% or more.

6. The curable resin composition for three-dimensional molding according to claim 1,
wherein the cationic polymerizable compound (A) is an alicyclic epoxy compound.

7. The curable resin composition for three-dimensional molding according to claim 6,
wherein the alicyclic epoxy compound is a compound represented by any one of following Formulae (1) to (3): 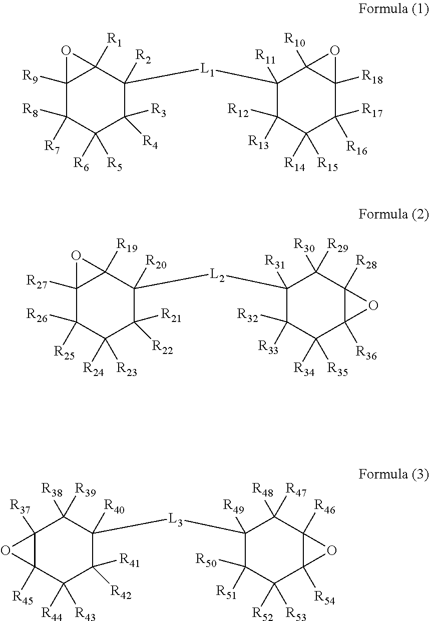
where R₁ to R₅₄ each represent a hydrogen atom, a hydroxyl group, or an alkyl group having 1 to 6 carbon atoms, and
L₁ to L₃ each represent a divalent linking group having an ether structure, an ester structure, or a carbonate structure.

8. The curable resin composition for three-dimensional molding according to claim 7,
wherein R₁, R₉, R₁₀, R₁₈, R₁₉, R₂₇, R₂₈, R₃₆, R₃₇, R₄₅, R₄₆, and R₅₄ are hydrogen atoms.

9. The curable resin composition for three-dimensional molding according to claim 7,
wherein the cationic polymerizable compound (A) is represented by the Formula (3), and R₃₇ to R₅₄ are hydrogen atoms.

10. The curable resin composition for three-dimensional molding according to claim 9,
wherein L₃ has an ester structure.

11. A method of producing a three-dimensional molded product, comprising:
photocuring a curable resin composition layer by layer based on slice data to mold a molded product,
wherein the curable resin composition:
a cationic polymerizable compound (A);
an inorganic particle (B); and
a curing agent (C),
wherein a flexural modulus of a cured product obtained by polymerizing a composition consisting of the cationic polymerizable compound (A) and the curing agent (C) is 2.0 GPa or more,
the inorganic particle (B) has a layered crystal structure, a content of the inorganic particle (B) is 10 parts by mass or more and 30 parts by mass or less, relative to total 100 parts by mass of the cationic polymerizable compound (A) and the inorganic particle (B), and
the curable resin composition having a thickness of 200 μm has a light transmittance including forward scattering of 0.1% or more at a wavelength of 365 nm or 405 nm.

12. The method of producing a three-dimensional molded product according to claim 11, further comprising:
performing heat irradiation on the molded product to obtain the three-dimensional molded product.
